(19) United States
(12) Patent Application Publication
(10) Pub. No.: US 2020/0255547 A1
(43) Pub. Date: Aug. 13, 2020

(54) SIMPLIFIED PROCESS FOR MAKING LOW VISCOSITY CELLULOSE ETHER

(71) Applicant: DOW GLOBAL TECHNOLOGIES LLC, Midland, MI (US)

(72) Inventors: Robert Appell, Midland, MI (US); Jorg Theuerkauf, Midland, MI (US); Matthias S Ober, Midland, MI (US); Matthias Knarr, Bomlitz (DE)

(21) Appl. No.: 16/651,159

(22) PCT Filed: Jul. 26, 2018
(86) PCT No.: PCT/US2018/043798

§ 371 Date: Mar. 26, 2020

Related U.S. Application Data
(60) Provisional application No. 62/567,349, filed on Oct. 3, 2017.

(51) Int. Cl. C08B 11/08

(52) U.S. Cl. CPC C08B 11/08

(57) ABSTRACT

A process for preparing cellulose ether includes (a) alkylation and etherification of cellulose to form an initial cellulose ether, (b) washing and filtering of the initial cellulose ether; (c) optionally granulating the cellulose ether; (d) compounding the cellulose ether to form a dough; (e) optionally disposing the cellulose ether into a buffer tank; and (f) drying the cellulose ether dough to obtain a final cellulose ether with a lower viscosity than the initial cellulose ether; where the process is characterized by introducing an aqueous catalyst and a peroxy-containing oxidizer to the cellulose ether during at least one of steps (c)-(f), introducing an aqueous enhancer during at least one of steps (c)-(e) and wherein the process is free of drying an isolating cellulose ether after (a) and before drying the final cellulose ether.

### CROSS-REFERENCE TO RELATED APPLICATION

This application represents a national filing under 35 U.S.C. 371 of International Application No. PCT/US18/043798 filed Jul. 26, 2018, and claims priority of U.S. Provisional Application No. 62/567,349 filed Oct. 3, 2017, the contents of all prior applications are incorporated herein by reference in their entirety for all purposes.

### BACKGROUND OF THE INVENTION

### Field of the Invention

The present invention relates to a single process for making low viscosity cellulose ether from higher viscosity cellulose ether.

### Introduction

A two-step process is commonly used for preparing cellulose ether having moderate and low viscosities. The first step is to prepare an initial cellulose ether and then wash, compound and dry the initial cellulose ether to form an initial cellulose ether powder. The second step is to subject the initial cellulose ether powder to acid hydrolysis, neutralization and drying to convert the initial cellulose ether into a lower viscosity cellulose ether.

The two-step process requires two reaction steps, two drying steps and two sets of equipment. As a result, the two step process is equipment intensive and requires energy to dry cellulose ether product twice. Moreover, the two step process typically requires use of halogenated acid to conduct acid hydrolysis to reduce the viscosity of the cellulose ether. Such a hydrolysis step undesirably requires handling of corrosive acids as well as tends to produce cellulose ether product that is either unstable in viscosity due to residual acid in the final product or that requires extensive quenching efforts to eliminate residual acid from the final product.

It is desirable to be able to identify a process for producing cellulose ether and then reducing the viscosity of the cellulose ether all a single continuous process with a single drying step at the end in order to reduce the equipment requirements and energy requirements. Moreover, it is desirably for such a process to be free of acid hydrolysis using halogenated acid in order to avoid handling the corrosive acids and aforementioned challenges with residual acid in the final product.

### BRIEF SUMMARY OF THE INVENTION

The process of the present invention provides a process for producing cellulose ether and then reducing the viscosity of the cellulose ether all a single continuous process with a single drying step at the end. Moreover, present invention provides such a process that can be free of acid hydrolysis using halogenated acid. The process of the present invention can be continuous including synthesis of a relatively high viscosity cellulose ether, reduction of cellulose ether viscosity and isolation of a relatively low viscosity cellulose ether with only one drying step at the end to isolate the relatively low viscosity cellulose ether.

The present invention is a result of surprisingly and unexpectedly discovering that a redox active transition metal based catalyst and peroxy-containing oxidizer can be introduced after washing the cellulose ether product and without drying the cellulose ether product in order to convert the cellulose ether product into a lower viscosity cellulose ether without requiring drying, isolating, or a separate acid-hydrolysis step. The process can be free from introduction of acid and quenching base to conduct a hydrolysis reaction to reduce cellulose ether viscosity.

Moreover, it has further been surprisingly and unexpectedly discovered that an enhancer can be introduced during in the process of the present invention in order to reduce discoloration of the cellulose ether in order to provide a whiter cellulose ether product. The enhancer is one or more component selected from a group consisting of 5-substituted 3,4-dihydroxyfuranone (such as ascorbic acid and erythorbic acid), metabisulfite salt, sulfite salt, thiosulfate salt and sulfur dioxide.

It has been further surprisingly and unexpectedly discovered that impact mill drying of the final cellulose ether product is particularly beneficial to concurrently remove both moisture and residual oxidizer from the final cellulose ether without extensively concentrating the oxidizer and causing undesired degradation of the resulting cellulose ether. Even more surprisingly and unexpectedly, adding water to the cellulose ether product prior to impact milling actually increases the efficiency of removing oxidizer during the impact mill drying step.

Even more, it has been surprisingly and unexpectedly discovered that a quencher can be introduced in the process of the present invention in order to stabilize the resulting cellulose ether dough from degradation upon extended storage.

In a first aspect, the present invention is a process for preparing cellulose ether, the process comprising: (a) alkylation and etherification of cellulose to form an initial cellulose ether; (b) washing and filtering the initial cellulose ether to produce a washed cellulose ether; (c) optionally, granulating the washed cellulose ether; (d) compounding the washed cellulose ether to form a compounded cellulose ether dough; (e) optionally, further mixing into the compounded cellulose ether additional components; and (f) drying the compounded cellulose ether dough to obtain a final cellulose ether having a lower viscosity than the initial cellulose ether; wherein the process is characterized by: (i) introducing an aqueous catalyst that is a redox active transition metal based catalyst during at least one of the following steps: granulation (c), compounding (d), mixing step (e), and drying step (f); and (ii) introducing a peroxy-containing oxidizer during at least one of the following steps: granulation (c), compounding (d), mixing step (e), and drying step (f); and (iii) introducing an aqueous enhancer during at least one of the following steps: granulation (c), compounding (d), and mixing step (e); wherein the aqueous enhancer is selected from a group consisting of 5-substituted 3,4-dihydroxyfuranone, metabisulfite salt, sulfite salt, thiosulfate salt and sulfur dioxide; and (iv) being free of drying and isolating cellulose ether after the alkylation in step (a) and before the drying the compounded cellulose ether to obtain the final cellulose ether in step (f).

The process of the present invention is useful for efficient manufacturing of cellulose ethers, especially those having a viscosity of 8,000 milliPascals*seconds (mPa·s) and lower.

### BRIEF DESCRIPTION OF THE DRAWINGS

FIGS. 1, 3, 5, 7 and 9 provide plots of degradation half-life (time to go from 4000 mPa·s to 2000 mPa·s) for various solutions of the Examples.

FIGS. 2, 4, 6, 8 and 10 provide plots of the discoloration of various solutions of the Examples.

FIGS. 11 and 12 illustrate comparative viscosity drops for different degradation reaction runs as described in the Examples.

FIG. 13 illustrates viscosity curves over time for negative controls from the Examples.

### DETAILED DESCRIPTION OF THE INVENTION

“And/or” means “and, or alternatively”. Ranges include endpoints unless otherwise stated. Test methods refer to the most recent test method as of the priority date of this document unless a date is indicated with the test method number as a hyphenated two digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut fur Normung; and ISO refers to International Organization for Standardization.

“Cellulose ether” includes alkyl cellulose ethers and hydroxyalkyl cellulose ethers. As particular examples, cellulose ether includes any one or combination of more than one of the following: methyl cellulose, ethyl cellulose, hydroxethyl methylcellulose, hydroxypropyl methylcellulose, hydroxyethyl methylcellulose, ethylhydroxy ethylcellulose, and hydroxybutyl methylcellulose. Of particular interest are alkylcellulose ethers such as methyl cellulose and hydroxypropyl methylcellulose.

Herein, unless otherwise noted in the context of the teaching, determine viscosity for a cellulose ether at 20 ° C. by preparing a 2 weight-percent (wt %) aqueous solution of the cellulose ether by the method set forth in USP40-NF35, page 4552 under “Hypromellose”.

Viscosity of cellulose ethers follow molecular weight of the cellulose ether such that higher molecular weight cellulose ethers have higher viscosities than lower molecular weight cellulose ethers. Hydrolysis of higher molecular weight cellulose ethers yields lower molecular weight/lower viscosity cellulose ethers. Herein, units of milliPascal*seconds (mPa·s) and centipoise (cP) are interchangeable.

The present invention is a process for producing cellulose ether by making an initial cellulose ether and then reducing the viscosity of the initial cellulose ether. Unlike current processes, the process of the present invention does not require isolation of the initial cellulose ether after it is make and prior to reducing its viscosity nor does it require use of halogenated acid hydrolysis to reduce cellulose ether viscosity. In fact, the present invention is desirably free of either of these process steps.

The process of the present invention comprises the following steps: (a) alkylation and etherification of cellulose to form an initial cellulose ether; (b) washing and filtering the initial cellulose ether to produce a washed cellulose ether; (c) optionally, granulating the washed cellulose ether; (d) compounding the washed cellulose ether to form a compounded cellulose ether dough; (e) optionally, further mixing into the compounded cellulose ether additional components; and (f) drying the compounded wet cellulose ether dough to obtain a final cellulose ether having a lower viscosity than the initial cellulose ether. Process steps (c) and (e) are optional, which means they are not required for the broadest scope of the present invention but either or both can be included as part of the present invention.

Step (a): Alkylation and Etherification of Cellulose Ether

The alkylation and etherification of cellulose ether to form an initial cellulose ether is, in the broadest scope of the present invention, not limited and can be done by any method. For example, U.S. Pat. No. 6,261,218 in column 3, line 9 through line 67 discloses a suitable method for alkylation and etherification of cellulose ether that is suitable for use in the present invention to prepare an initial cellulose ether.

A general process suitable for use in alkylation and etherification of cellulose ether is as follows: Provide a cellulose pulp, typically cotton or wood pulp, that is initially in powder form or in granules. Alkylate the cellulose pulp in a reactor with an alkaline hydroxide, preferably sodium hydroxide. For example, alkylation can occur by steeping in a bath or stirred tank containing aqueous hydroxide or spraying the aqueous hydroxide directly on dry pulp. The aqueous hydroxide is preferably used at an alkaline hydroxide content of 30-70 percent by weight based on weight of the water. Retention rates preferably range from 5 to 90 minutes. The temperature of alkylation preferably ranges from 30 degrees Celsius (° C.) to 60° C. Achieve uniform swelling and alkali distribution in the pulp by mixing and agitation. The headspace of the alkylation reactor can be evacuated or partially or substantially purged with an inert gas such as nitrogen to control depolymerization of the cellulose ether product. Unreacted alkaline hydroxide may be neutralized with an acid such as hydrochloric acid, nitric acid, or acetic acid or may be neutralized with a slight excess of an etherifying agent.

A general process suitable for etherification of the alkylated cellulose ether is as follows: place the alkylated cellulose ether in a reactor if not already in one and elevate the pressure in the reactor to a pressure of 650 kilopascals (kPa) or higher, more typically 690 kPa or higher, 700 kPa or higher 750 kPa or higher or even 800 kPa or higher while at the same time to a pressure typically of 4000 kPa or lower, 3500 kPa or lower, 3000 kPa or lower, 2500 kPa or lower, or even 2100 kPa or lower for about 0.5 to 16 hours. Typical etherifying agents include the lower alkyl halides and epoxides such as methyl chloride, ethyl chloride, ethylene oxide, propylene oxide, butylene oxide, and mixtures thereof. For instance, methyl chloride may be used to make methylcellulose and a mixture of methyl chloride and propylene oxide may be used to make hydroxypropylmethyl cellulose. The use of methyl chloride results in the by-product formation of sodium chloride. Preferably, a slight excess of the etherifying agent is added to react with any unreacted alkaline hydroxide remaining from alkylation. The resulting cellulose ether is the initial cellulose either and desirably has a viscosity of 200 milliPascal·second (mPa·s) or higher, preferably 4000 mPa·s or higher and at the same time is typically 400,000 mPa·s or lower.

Desirably, the initial cellulose ether has a structure as represented by Formula I, where the cellulose ether has repeating units as specified in the brackets:

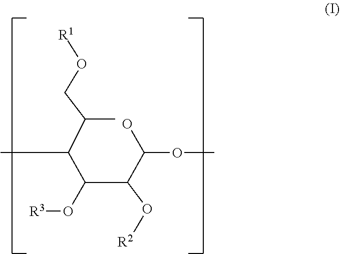

where each occurrence of R¹, R² and R³ is independently selected from a group consisting of hydrogen an linear or branched C₁-C₅ alkyl groups, the alkyl groups being optionally substituted with one or more than one C₂-C₅ linear or branched alkoxy groups or hydroxyl groups, provided that at least one of the repeating units R¹, R² and R³ are each other than hydrogen.

Step (b): Washing and Filtering of Initial Cellulose Ether

Wash the initial cellulose ether to remove salt and other reaction by-produces of the alkylation/etherification. Any solvent in which salt is soluble is suitable for washing, but hot water is preferable due to its availability and environmental compatibility. Desirably, washing only uses water and is free of any organic solvents. Desirably, wash the initial cellulose ether in the etherification reactor and/or downstream from the etherification reactor. Before or after washing, the cellulose ether may be stripped by exposure to steam to reduce residual organic content.

Filter the initial cellulose ether after washing. Desirably, filter by any method known in the art. For example, filtering methods centrifugation, filter pressing, vacuum filtration, pressurized filter plate methods are all suitable means for filtering wash liquid from the initial cellulose ether.

Step (c): Optional Granulating of Washed Cellulose Ether

The washed cellulose ether can be, and desirably is, granulated prior to compounding to form a compounded cellulose ether dough. Granulating serves to agglomerate the washed cellulose ether into larger particulate form. Granulation can be done by any method suitable for granulating cellulose ether. For example, milling using, for example, a ball mill or an impact pulverizer is a suitable method for granulating. Typical retention times when using a ball mill or impact pulverizer range from about 20 to out 120 minutes. Typically, the washed cellulose ether has an average particle size in a range of 25 to 1000 micrometers as determined by mechanical sieve where average particle size corresponds to the particle size where half the mass is retained on a sieve and half the mass passes through the sieve.

Step (d): Compounding Washed Cellulose Ether

The washed cellulose ether is compounded to form a compounded cellulose ether dough. Generally, compounding occurs by continuous high shear mixing in order to homogenize the moisture in the cellulose ether into the cellulose ether to form a dough-like material. Suitable means for high shear mixing include compounding extruders such as twin screw extruder. Other suitable high shear mixers include kneader and granulators.

Additional water can be added (or not) to the cellulose ether during compounding to facilitate compounding. The moisture content of the cellulose ether is typically 20-90, 30-75 40-75 wt % water relative to total washed cellulose ether weight (weight of cellulose ether and moisture).

Lower temperatures are desirable for compounding to facilitate water absorption into the cellulose ether. Generally, compounding is done at a temperature in a temperature range of 2-80° C.

Step (e): Optional Feeding Compounded Cellulose Ether Through a Buffer Tank

The compounded cellulose ether can be fed into a vessel (“buffer tank”) from the compounding step to buffer the rate at which the compounded cellulose ether is fed to the drying step. Use of a buffer tank is desirable to provide a residence time for the components in the cellulose ether to react. Use of a buffer tank is also desirable to dampen variability in upstream feed rates so that compounded cellulose ether can be fed to into the drying step at a more constant rate. Dwell times for the cellulose ether in the buffer tank desirably are in a range from one to 15 minutes.

The buffer tank desirably includes a low shear agitator or mixer to keep compounded cellulose ether mobile. Examples of suitable buffer tank include a tank with entrance and exit ports and with a paddle agitator that keeps the compounded cellulose ether moving towards the exit port of the buffer tank.

Step (f): Drying the Compounded Cellulose Ether Dough

Dry the compounded cellulose ether dough to obtain a final cellulose ether having a lower viscosity than the initial cellulose ether.

Drying is advantageously done by impact milling the compounded cellulose ether dough. Impact mill drying is particularly beneficial to concurrently remove both moisture and residual oxidizer without extensively concentrating the oxidizer, which can occur with other forms of drying. Removing the oxidizer is valuable to avoid undesired degradation of the cellulose ether, which can cause the viscosity of the final cellulose ether to drift during the drying process. Removing the oxidizer efficiently during drying precludes undesirable process characteristics from alternative processes such as: (i) discoloration of cellulose ether as a result of extensive heating to remove moisture an oxidizer; (ii) extended drying times due to use of a washing step to remove oxidizer; and (iii) reduction in cellulose ether yield resulting from adding extensive quencher to remove oxidizer. Removing oxidizer efficiency through impact milling facilitates greater control over the viscosity of the final cellulose ether and stability of the viscosity of the final cellulose ether without detrimental effects of alternative processes.

Alternatively, drying of the cellulose ether can be done by any other means known in the art such as steam tube drying, contact drying, and convective drying (such a flash drying) instead of impact milling. Spreading of the compounded cellulose ether into a paste prior to drying by such methods facilitates the drying process in steam tube drying, contact drying and convective drying processes.

Surprisingly, adding water to the cellulose ether prior to drying in step (f), especially when drying is done by impact milling. Adding water prior to the drying step actually increases the efficiency of removing oxidizer during the drying step. Hence, it is desirable to add water either during compounding step (d) or optional step (e). Desirably, the total amount of water added during steps (d) and (e) are such that the pre-drying water content is 45-75 wt % based on combined weight of water and cellulose ether component.

Process Characteristics

The process of the present invention is characterized by at least the following four characteristics:
(i) an aqueous catalyst is added (that is, introduced) during any one or combination of more than one of the following steps: granulation (c), compounding (d), mixing step (e), and drying step (f);
(ii) a peroxy-containing oxidizer is added (that is, introduced) during any one or any combination of more than one of the following steps: granulation (c), compounding (d), mixing step (e), and drying step (f);
(iii) an aqueous enhancer is added (that is, introduced) during any one or any combination of more than one of the following steps: granulation (c), compounding (d), and mixing step (e); and
(iv) the process is free of drying and isolating cellulose ether after the alkylation in step (a) and before the drying the compounded cellulose ether to obtain the final cellulose ether in step (f).

“Introduced” in these characteristics means added to the cellulose ether component of the designated step. The “cellulose ether component” includes the initial cellulose ether, the washed cellulose ether, and the compounded cellulose ether dough.

Process Characteristic (i): Aqueous Catalyst Addition

The aqueous catalyst is a redox active transition metal based catalyst in water. Desirably, the catalyst is any one or any combination of more than one selected from a group consisting of iron salt, copper salts and zinc(II) oxide. Preferably, the iron salts are one or more selected from a group consisting of iron(II) sulfate and iron(III) sulfate. Preferably, the copper salt is one or more copper sulfate. Desirably, the aqueous catalyst is introduced to establish a total catalyst concentration (that is, sum of all catalyst introduced in the process) of 0.01 weight-percent (wt %) or more, 0. 0.05 wt % or more, 0.1 wt % or more or 0.5 wt % or more and at the same time is generally one wt % or less with wt % catalyst relative to dry cellulose ether component weight.

Process Characteristic (ii): Oxidizer Addition

The peroxy-containing oxidizer is desirably one or any combination of more than one selected from hydrogen peroxide, inorganic persulfate and organic persulfate. Desirably, the peroxy-containing oxidizer is introduced to the process at a total concentration (sum of all peroxide-containing oxidizer introduced in the process) that one or more, preferably 5 or more, even 6 or more times the weight of the total catalyst that is introduced to the process and at the same time is typically 500 or less, more typically 100 or less, even more typically 50 or less and can be 30 or less, 25 or less and even 20 or less times the weight of the total catalyst that is introduced to the process.

Process Characteristic Aqueous Enhancer Addition

The aqueous enhancer is one or a combination of more than one Fenton enhancer in water. The Fenton enhancer is any one or more than one component selected from a group consisting of 5-substituted 3,4-dihydroxyfuranones, metabisulfite salts, sulfite salts, thiosulfate salts, ascorbic acid salts and sulfur dioxide. Examples of suitable 5-substituted 3,4-dihydroxyfuranones include ascorbic acid and erythorbic acid and isomers thereof. The total amount of aqueous enhancer introduced during the process is desirably sufficient to achieve a total Fenton enhancer concentration (that is, amount of all Fenton enhancer introduced during the process) that is 0.01 or more, preferably 0.05 or more, more preferably 0.08 or more and can be 0.10 or more, one or more, 5 or more, 10 or more, 25 or more, 50 or more and even 75 or more times the weight of total catalyst introduced during the process and at the same time is generally 100 or less, 75 or less, 50 or less 25 or less, 10 or less and can be 5 or less and even one or less times the weight of total catalyst introduced during the process.

The enhancer provides at least the following benefits to the process of the present invention with respect to a similar process without the enhancer: (1) faster degradation of the initial cellulose ether to a lower viscosity cellulose ether; and/or (2) less discoloration of the final cellulose ether (that is, a white final cellulose ether). Faster degradation is desirable to make the reaction more efficient and less costly. Less discoloration is also valuable for producing cellulose ether for application where whiteness is important, such as pharmaceutical applications and applications where subsequent pigmenting is used and there is a need to accurately achieve reproducible color regardless of cellulose ether batch.

Process Characteristic (iv): Free of Drying and Isolating Cellulose Ether Prior to Step (f)

The process of the present invention advantageously can be a continuous process that takes a cellulose pulp all the way from alkylation and etherification to form a cellulose ether through reducing the viscosity of the cellulose ether without need to dry or isolate the cellulose ether along the way. That means the process of the present invention avoids the drying and isolation steps required in presently used processes for preparing a cellulose ether and then reducing its viscosity. In fact, the process of the present invention can be one continuous process that goes from alkylation and etherification of a cellulose pulp to form an initial cellulose ether through reduction of the viscosity of the initial cellulose ether and isolation of the reduced viscosity cellulose ether. In that regard, the process of the present invention is free of drying and isolating cellulose ether anywhere after step (a) and prior to step (f). Moreover, the cellulose ether formed in step (a) can go through the process of the present invention without any reduction in water content until drying in step (f). As such, the process obviates need for separate reactors for alkylation/etherification and degradation (viscosity reduction). Such a single process increases energy and time efficiency of the production of mid to low viscosity cellulose ethers by eliminating an intermediary drying and isolating step.

Optional Quencher

The process can further include addition of a quencher during compounding after addition of catalyst, oxidizer and enhancer at any time during or after compounding step (d). Addition of a quencher provides further stability to the final cellulose ether viscosity by consuming residual oxidizer and/or catalyst.

The optional quencher can be any one or any combination of more than one component selected from the four groups of quenchers described below. Each group of quencher works by a slightly different mechanism. Quenchers from different groups can be mixed with quenchers within the same group or one or more than one quencher from another group, or only a single quencher selected from one of the groups can be used.

Quencher Group I: Metabisulfite salt, sulfite salt, thiosulfate salt, and sulfur dioxide. Quenchers from Group I act much like the Enhancer additive and enhance the reaction rate to consume oxidizer. When using a quencher from Quencher Group I, the quencher concentration is typically in a molar ratio of 1:1 and 0.001:1 relative to oxidizer introduced during the process. When the quencher is identical to a listed enhancer, the use of the material as a “quencher” is evident because it is introduced some time after addition of the enhancer and oxidizer and catalyst have been introduced.

Quencher Group II: EC1.11.1 class peroxidases (as defined by Nomenclature Committee of the International Union of biochemistry and Molecular Biology) such as catalase, and manganese(II) through manganese(VII) salt oxides and dioxides. Quenchers from this Group II catalyzes the degradation of hydrogen peroxide to water an oxygen by a mechanism that does not introduce hydroxyl radical intermediates. Hence, quenchers from Group II are useful for removing hydrogen peroxide oxidizer to terminate viscosity reduction of the cellulose ether. When used, quenchers from Quencher Group II are typically present at a concentration that is in a molar ratio of 0.01:1 to 0.0001:1 relative to oxidizer introduced during the process.

Quencher Group III: one or any combination of more than one chelant such as ethylenediaminetetraacetic acid (EDTA) at a molar ratio of 4:1 and 1:4 relative to catalyst and/or citric acid at a molar ratio of 4:1 to 1:4 relative to catalyst or between a molar range of 0.05 to 0.2 millimoles per gram of cellulose ether. Chelants serves a quenchers by complexing with the metal catalyst, thereby slowing or ceasing the degradation reaction of the cellulose ether.

Quencher Group IV: one or both of ascorbic acid and erythorbic acid. The quenchers of Group IV serve to accelerate the consumption of hydrogen peroxide thereby consuming the oxidizer in a way that does not contribute to viscosity degradation of the cellulose ether. Quencher Group IV materials, when present as a quencher, are typically at a molar concentration of 0.05 to 0.2 millimoles per gram of cellulose ether.

The present process advantageously contains quencher to produce a stable final cellulose ether. However, the process of the present invention can be free of any one or any combination or more than one quencher mentioned. For example, the process of the present invention can include addition of EDTA or be free from addition of EDTA. Moreover, the process can be free of all quenchers mentioned.

The process of the present invention can be free of cobalt and manganese salts. The process of the present invention can be free of any transition metal salts other than those of iron, copper and zinc.

### EXAMPLES

For convenience of experimentation, the following examples were conducted starting with an initial cellulose ether powder that is hydrated to represent and simulate washed initial cellulose ether of the presently claimed invention. Results of the following examples are expected to fully represent results obtained by alkylating and etherifying a cellulose to form an initial cellulose ether as described above as well as washing and filtering the cellulose ether as described above and then proceeding through a granulating step or directly into a degradation step as illustrated herein below. In other words, the following results are independent of whether the initial cellulose ether is dried and isolated prior to degradation or whether the initial cellulose ether is transferred from washing and filtering after alkylation/etherification to the degradation (directly or through a granulation step).

Comp Ex A-H and Ex 1: Synergy of Catalyst+Enhancer+Oxidizer

For each of Comparative Examples (Comp Exs) A-H and Example (Ex) 1, prepare 200 grams of cellulose ether wet cake at a 50 wt % moisture level by hydrating hydroxypropyl methylcellulose having a viscosity of 2663-4970 mPa·s, a Methoxy wt % of 28-30 and a hydroxypropyl wt % of 7-12 (for example, METHOCELTM E4M grade hydroxypropyl methylcellulose; METHOCEL is a trademark of The Dow Chemical Company) in the manner described by Timothy Thomson, et al. in U.S. Pat. No. 4,845,206.

Load the cellulose ether wet cake into a 5-liter Lodige ploughshare mixer at 25° C. and turn on the mixer. Dissolve the designated amount of iron(III) sulfate and/or ascorbic acid (See Table 1) in 20 grams of deionized water and add the solution to the cellulose ether wetcake at a rate of 60 milliliters per minute while mixing. Continue mixing at 25° C. for 25 minutes to form a dough mixture.

Transfer the dough mixture to a Linden double-Z batch lab kneader and add the designated amount of 30% hydrogen peroxide (see Table 1) in less than one minute while mixing at 25° C. Mix the resulting dough at 25° C. for 30 minutes. For samples containing hydrogen peroxide, consume residual peroxide using commercial Catalase enzyme to achieve a dough free of peroxides by starch-iodide test strips.

Remove dough from the kneader, manually break into small pieces and dry in a convention oven at 75° C. for 10 hours. Grind the dried material and measure “Final Solution Viscosity” as a 2 wt % aqueous solution by the method set forth in USP40-NF35, page 4552 under “Hypermellose”.

TABLE 1

| | | | | | | Final |
|---|---|---|---|---|---|---|
| | | | Ascorbic | DI | 30 wt % | Solution |
| | | FeSO4 | Acid | Water | peroxide | Viscosity |
| Sample | Comment | (g) | (g) | (g) | (g) | (mPa*s) |
| Comp Ex A | Dough without | 0 | 0 | 20 | 0 | 3787 |
| | processing | | | | | |
| Comp Ex B | Dough though | 0 | 0 | 20 | 0 | 2433 |
| | Kneader | | | | | |
| Comp Ex C | Peroxide Only | 0 | 0 | 20 | 10 | 3016 |
| Comp Ex D | Iron Only | 0.3 | 0 | 20 | 0 | 634 |
| Comp Ex E | Ascorbic Acid Only | 0 | 0.3 | 20 | 0 | 668 |
| Comp Ex F | Iron/Peroxide | 0.3 | 0 | 20 | 10 | 47 |
| Comp Ex G | Ascorbic | 0 | 0.3 | 20 | 10 | 137 |
| | Acid/peroxide | | | | | |
| Ex 1 | Iron/Ascorbic | 0.3 | 0.3 | 20 | 10 | 10 |
| | Acid/Peroxide | | | | | |

The results in Table 1 reveal a synergistic effect of combining all three of a catalyst, enhancer and oxidizer in achieving viscosity degradation of cellulose ether dough.

Comp Ex I-L & Exs 2-15: Synergy of Catalyst+Enhancer+Oxidizer +Cellulose Ether

Prepare cellulose ether feedstock wet cake in the manner described by Timothy Thomson, et al. in U.S. Pat. No. 4845206 using the appropriate cellulose ether (See Table 2).
“A4M” corresponds to methylcellulose having a viscosity of 2663-4970 mPa·s, a Methoxy wt % of 27.5-31.5 (for example, METHOCEL A4M brand methylcellulose ether.
“E4M” corresponds to hydroxypropyl methylcellulose having a viscosity of 2663-4970 mPa·s, a Methoxy wt % of 28-30 and a hydroxypropyl wt % of 7-12 (for example, METHOCEL E4M grade hydroxypropyl methylcellulose)
“K4M” corresponds to hydroxypropyl methylcellulose having a viscosity of 2663-4970 mPa·s, a Methoxy wt % of 19-24 and a hydroxypropyl wt % of 4-12 (for example, METHOCEL K4M grade hydroxypropyl methylcellulose).

Load the cellulose ether wet cake feedstock (30 kilograms on a dry basis; 48 wt % moisture) into a one cubic meter granulator and add a solution of iron sulfate and ascorbic acid in water while mixing (See Table 2 for amounts of each). Mix for 30 minutes. Feed the resulting mixture at a constant rate into a twin-screw compounder co-currently with 30% hydrogen peroxide diluted with water as indicated in Table 2. The mixture has an estimated dwell time in the compounder that is approximately three minutes. The cellulose ether exiting the compounder has a lower viscosity and enters a feed tank for approximately 5 minutes from which it proceeds to an impact mill to mill dry to a moisture level below 5 wt %. Resulting viscosity for the dry cellulosed ether is reported in Table 2.

Comp Exs I and J demonstrate the impact of peroxide depolymerization in an absence of metal catalyst on final product viscosity.

Comp Exs K and L demonstrate the impact of the peroxide depolymerization in the absence of ascorbic acid enhancer on final product viscosity.

Exs 2-9 demonstrate the impact of the peroxide depolymerization over a range of catalyst, enhancer and hydrogen peroxide levels on final product viscosity.

The data also reveals the effectiveness of impact milling in removing oxidizer as well as water from the final cellulose ether.

Exs 10-15 illustrate the impact of increasing ascorbic acid level on final cellulose ether viscosity over two different levels of peroxide.

TABLE 2

| | | | Ascorbic | 30% | | wt % | Compounder | Final | Solution |
|---|---|---|---|---|---|---|---|---|---|
| | Cellulose | FeSO₄ | Acid | H₂O₂ | Water | total | temp | Viscosity | Peroxide |
| Sample | Ether | (g) | (g) | (kg) | (kg) | moisture | (° C.) | (mPa*s) | (ppm) |
| Ex 2 | A4M | 90 | 150 | 1.3 | 19.8 | 62 | 30 | 99 | 0 |
| Ex 3 | A4M | 60 | 150 | 1.3 | 19.8 | 62 | 30 | 154 | 0 |
| Ex 4 | A4M | 30 | 150 | 1.3 | 19.8 | 62 | 30 | 208 | 0.5 |
| Comp Ex I | A4M | 0 | 150 | 1.3 | 19.8 | 62 | 30 | 543 | 5 |
| Ex 5 | E4M | 90 | 150 | 2.6 | 19.8 | 62 | 50 | 19 | 0 |
| Ex 6 | E4M | 120 | 200 | 2.6 | 19.8 | 62 | 50 | 10 | 0 |
| Ex 7 | K4M | 90 | 150 | 1.3 | 19.8 | 62 | 50 | 17 | 0 |
| Ex 8 | K4M | 60 | 150 | 1.3 | 19.8 | 62 | 50 | 25 | 0 |
| Ex 9 | K4M | 30 | 150 | 1.3 | 19.8 | 62 | 50 | 71 | 2 |
| Comp Ex J | K4M | 0 | 150 | 1.3 | 19.8 | 62 | 30 | 287 | 10 |
| Comp Ex K | K4M | 60 | 0 | 1.3 | 19.8 | 62 | 49 | 335 | 5 |
| Ex 10 | K4M | 60 | 10 | 1.3 | 19.8 | 62 | 49 | 115 | 2 |
| Ex 11 | K4M | 60 | 25 | 1.3 | 19.8 | 62 | 49 | 57 | 0 |
| Ex 12 | K4M | 60 | 50 | 1.3 | 19.8 | 62 | 49 | 29 | 0 |
| Comp Ex L | K4M | 60 | 0 | 2.0 | 19.8 | 62 | 48 | 123 | 2 |
| Ex 13 | K4M | 60 | 10 | 2.0 | 19.8 | 62 | 48 | 57 | 2 |
| Ex 14 | K4M | 60 | 25 | 2.0 | 19.8 | 62 | 49 | 26 | 1 |
| Ex 15 | K4M | 60 | 50 | 2.0 | 19.8 | 62 | 49 | 18 | 0 |

Exs 16-20: Water Enhanced Oxidizer Removal

Examples 16-20 reveal the benefit of adding water prior to impact milling in order to remove more oxidizer during the drying process.

Heat an 8-liter Lodige Reaktor DVT 5 RMK from Lodige (Paderborn, Germany) to 60° C. After 45 minutes add 412.8 grams K4M cellulose ether (described above) and 400 grams of water in four 100 gram dosages over 7 minutes while mixing at 75 revolutions per minute with ploughshare mixing blades. Mix the resulting dough for 60 minutes at constant speed. Dissolve 0.55 grams of iron sulfate and 0.25 grams ascorbic acid in 150 grams of water and spray the resulting solution onto the dough while mixing at a constant speed over 5 minutes. Mix for an additional 25 minutes.

Transfer the dough directly to a 3.7 liter Kneader LUK 4-111-1 from Werner & Pfleiderer (DinkelsbUhl, Germany), which was heated to 55° C. one hour prior to the addition. Knead the dough in the kneader at 55° C. for 5 minutes. Prepare a solution of 25 grams of 30% hydrogen peroxide and water (4 g Ex 16, 30 g Ex 17, 60 g Ex 18, 90 g Ex 19 and 120 g Ex 20) and spray on the dough while kneading. Knead for another 5 minutes and then let rest without kneading for 10 minutes.

Transfer the dough to an impact milling device (Ultra-Rotor 15 (ID2132) from Jackering (Hamm, Germany)) for drying and milling. Use a mill speed of 14,000 revolutions per minute and set the temperature so that the temperature at the exit of the mill is in a range of 110-120° C. with a nitrogen gas flow of 40 cubic meters per hour and a screw speed of 10 revolutions per minute. Dry 400 grams of dough and discard to clean the device. Dry the remaining dough sample and then characterize it for residual hydrogen peroxide by the following solution peroxide evaluation: prepare a 2 wt % aqueous solution of the cellulose ether and then determine hydrogen peroxide concentration using commercial Starch-Iodine test strips (MQant 0.5-25 ppm) by immersing the strip into the aqueous solution for one second and removing. Compare the color of the test strip to the color standard from the manufacture after 90 seconds.

Table 3 contains the amount of water added to the 30% hydrogen peroxide prior to treating the dough as well as the resulting hydrogen peroxide concentration. Determine hydrogen peroxide concentration as the concentration in a 2 wt % aqueous solution of the cellulose ether dough.

TABLE 3

| Sample | Ex 16 | Ex 17 | Ex 18 | Ex 19 | Ex 20 |
|---|---|---|---|---|---|
| Added Water (g) | 4 | 30 | 60 | 90 | 120 |
| Hydrogen Peroxide (ppm) | 25 | 10 | 5 | 5 | 5 |

The data in Table 3 reveals that adding water prior to impact milling helps eliminate oxidizer during impact milling.

Solution Phase Screening Work

Work was done on cellulose ether solutions to screen suitable catalysts, enhancers and oxidizer. In the solution phase screening work, degradation reactions were conducted in small scale solutions of cellulose ether rather than on cellulose ether dough. Performance in the solution is expected to reflect performance in cellulose ether dough (such as is formed during the compounding step of the present invention) because the chemistry is the same.

For the solution phase screening work, a solution of cellulose ether is prepared and additives are added to the solution. The solution is then sealed into a vessel with stirring paddles extending in the solution and the paddles stirred at a constant rate by an electric motor. The electric current applied to a motor to stir the paddles in the solution is monitored. The electric current is proportional to the force needed to stir the solution, which is proportional to the viscosity of the solution. Therefore, the electric current applied to the motor of a paddles is proportional to the viscosity of the solution. The device is calibrated to various viscosity standards and a conversion factor to convert applied current to solution viscosity determined. Hence, by monitoring applied current the viscosity of the solution is monitored. The experiments determined the amount of time needed to go from original viscosity of 4000 mPa·s to 2000 mPa·s (which is designated here as the “degradation half-life”).

Results similar to these can also be obtained by monitoring solution viscosity while running the screening reactions in a HAAKE viscotester iQ using a torque range 0.2 nMm-100 nMn, rotational speed 0.1 rpm to 1500 rpm, Peltier temperature module TM-PE-C, HAAKE Rotor FL26 with “Connect Assist” microchip, and HAAKE Cup CB25 DIN for TM-PE-C.

Discoloration was also monitored for the solution in an effort to determine whether reaction compositions tended to introduce color to the cellulose ether during the reaction. Discoloration was monitored by ultraviolet/visible (UV/Vis) spectra, L*ab color and ΔE_{ab} discoloration. Measure UV/Vis spectra on a Shimadzu UV-3600 UV/VIS/NIR spectrometer using a 1 centimeter by 1 Centimeters acrylic single use cuvette. Record absorptions from 380 to 780 nanometers at 5 nanometer intervals. Calculate color coordinates from the convolution integral using ASTME E308 standard using CIE 1931 2° Standard Observer tristimulus values and a simulated D65 standard illumination source and a transformation of resulting XYZ coordinates to L*ab color coordinates as described in the same standard. Determine ΔE_{ab} discoloration values from L*ab color values via the formula ΔE_{ab}=((100−L*)²a²+b²)^{1/2}

Catalyst Stock Solutions

Prepare stock solutions of the catalyst candidates at 50 millimolar (mM) concentrations based on metal cation or catalytic species according to Table 4.

TABLE 4

| | Mw | Quantity | μmole salt/ | Added water |
|---|---|---|---|---|
| Candidate | (g/mol) | (mg) | μmole active | (mL) |
| FeSO₄*7H₂O | 278.01 | 139.0 | 500/500 | 10 |
| Fe(SO₄)₃ | 399.88 | 100.0 | 250/500 | 10 |
| CuSO₄*5H₂O | 249.69 | 125.9 | 500/500 | 10 |
| KMnO₄ | 158.03 | 79.0 | 500/500 | 10 |
| KI | 166.00 | 83.0 | 500/500 | 10 |
| TiO₂ (21 nm part.) | 79.87 | 39.9 | 500/500 | 10 |
| ZnO (<50 nm part.) | 81.41 | 40.7 | 500/500 | 10 |

Oxidizer Stock Solutions

Table 5 lists the oxidizer candidates.

TABLE 5

| | | amount of | Added | |
|---|---|---|---|---|
| | Mw | oxidizer | water | |
| Candidate | (g/mole) | (g/mM) | (mL) | Molarity |
| H₂O₂, 30% (inhib. | 34.01 | Used as | Used as | 9.79 |
| Free) | | purchased | purchased | |
| Peracetic acid, 32% in | 76.05 | Used as | Used as | 4.75 |
| acetic acid (abbreviated | | purchased | purchased | |
| herein as “perac. acid”) | | | | |
| Sodium persulfate | 249.69 | 4.99/20 | 500/500 | 10 |
| (abbreviated herein as | | | | |
| “persulf.”) | | | | |

Fenton Enhancer Stock Solutions

20 mL stock solutions of the following reagents were prepared at the concentration of 1 M. (1) Ascorbic acid—buffered with NaOH to pH 2 (calibrated pH meter), abbreviated as “Asc-pH2”, (2) ascorbic acid—buffered with NaOH to pH 5, abbreviated as “Asc-pH 5”, (3) citric acid—buffered with NaOH to pH 2, abbreviated as “Cit-pH2”, (4) citric acid—buffered with NaOH to pH 5, abbreviated as “Cit-pH 5”, (5) sodium persulfate, abbreviated as “persulfate”, (6) glucose, (7) potassium metabisulfite, abbreviated as “bisulfite” or “metabisulf.”, (8) erythorbic acid, buffered to pH 5, abbreviated as “Ery-pH 5” (9) sodium thiosulfate, abbreviated as “thiosulfate”. Between experiments, stock solutions were refrigerated.

Chelating Agent Stock Solutions

20 mL of a stock solution of EDTA-Na2 in water (50 mM) was prepared by stirring the appropriate amount of EDTA-Na2 in 20 mL of water.

Acids/Bases

0.1 M sodium hydroxide and 0.05 M sulfuric acid solutions were used as purchased.

Cellulose Ether Stock Solutions

Stock solutions of METHOCEL™ E4M brand cellulose ether were prepared as follows: 735 mL of 18.2 MΩ·cm-1 water was heated to a simmer and 15 g METHOCEL™ E4M brand cellulose ether was added. The suspension was stirred vigorously via overhead stirrer until the cellulose ether was fully suspended and no lumps remained. The solution was continued to stir at slowly (˜20 rpm) and allowed to cool to room temperature. Cellulose ether solution aliquots (20 g) were distributed into 30 mL VICAR glass vials.

Quenching Agent Stock Solutions

For potential stoichiometric quenchers, 20 mL of aqueous stock solutions with concentrations of 1N were prepared. (1) 1 M Ascorbic acid—buffered with NaOH to pH=2, (2) 1 M ascorbic acid—buffered with NaOH to pH=5, (3) 1M erythorbic acid—buffered with NaOH to pH=5, (4) 1M sodium hypophosphite, (5) 1 M urea, (6) 0.2 M tannic acid, (7) 1 M cysteine, (8) 0.5 M potassium metabisulfite, (9) 1 M sodium thiosulfate, (10) 1 M sucrose, (11) 1 M DMSO, (12) citric acid, buffered with NaOH to pH=5. (13) Sodium hypochlorite solution was used as purchased (“4-5% active Cl”≈0.634 M NaOCl). Potential catalytic or Fenton catalyst degrading quenchers were prepared as follows: (1) 10 mM sodium iodide in water, (2) 50 mM EDTA-Na2 in water. Bovine catalase stock solutions were prepared freshly at concentrations between 250 U/mL and 10000 U/mL by dissolving between 1.25 mg to 20 mg of lyophilisate (Aldrich) in 10 mL of microfiltered phosphate buffer (10 mM, pH=7.0). Aspergillus niger catalase was used as received from MP Biomedicals (solution of ≥1000 U/mL).

Baker Hydrogen Peroxide TestStrips

Baker hydrogen peroxide TestStrips are available from JT Baker and can be used interchangeably with other commercially avaialbe hydrogen peroxide test having a detection range of one to 100 mg/L hydrogen peroxide. A negative peroxide dip test result means that the test solution contain less than one mg/L hydrogen peroxide as determined by a dip testing with the test strip.

Catalyst Screening

Conduct 48 experiments as listed in Table 6 using the following procedure for each experiment. Add 20 gram (g) aliquots of 2 wt % solution of METHOCEL™ E4M to a glass vial and then add where applicable catalyst stock solution (100 microliters, corresponding to 5 micromole active catalyst) followed by sodium hydroxide (0.1N) or sulfuric acid (0.1N) solution as “pH modifier” (50 microliters corresponding to 5 micromole protons or hydroxyl anions) where indicated. Stir the reaction for 5 minutes at 300 rpm, after which add 30% hydrogen peroxide (400 microliters, diluted to 1 milliliter with distilled water, approximately 3.92 mmol) via syringe. Run the reactions for 3 hours while mixing at 300 rpm and at 25° C.

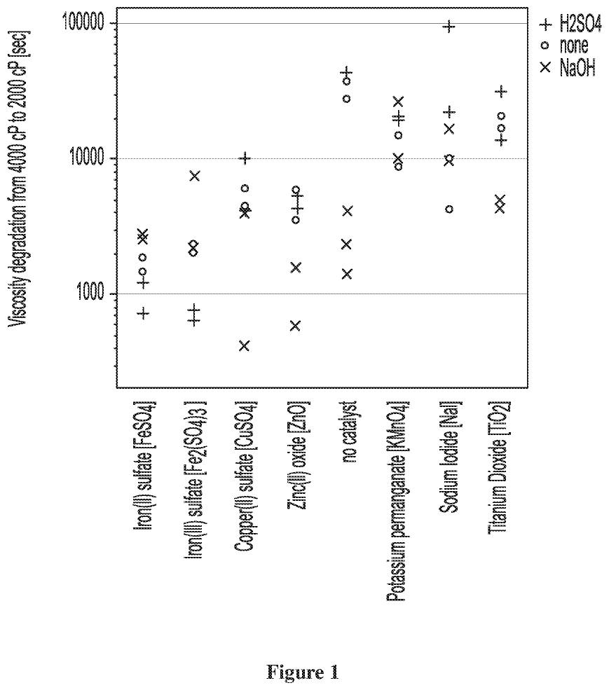

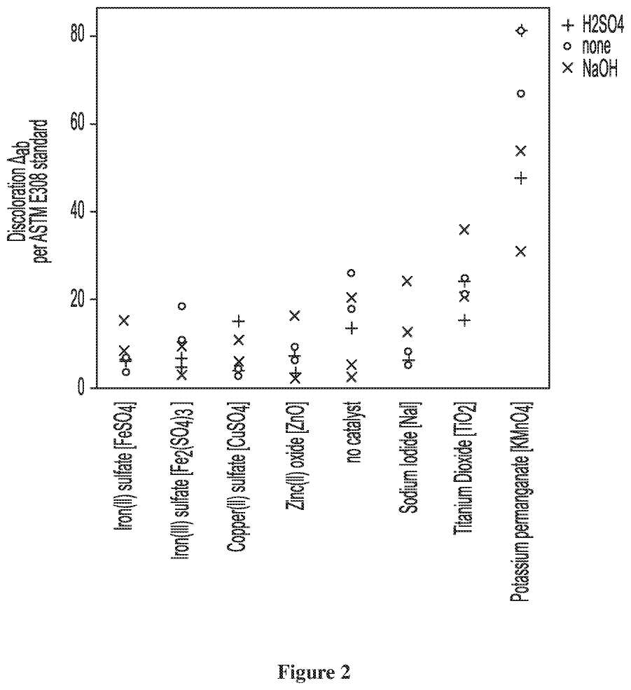

Results are recorded in Table 6 and plotted in FIGS. 1 and 2. Catalyst candidates that resulted in a degradation half-life that is shorter (less time for degradation from 4000 mPa·s to 2000 mPa·s) the faster the reaction and more desirable the catalyst. As evident in FIG. 1, iron(II) sulfate, iron(III) sulfate, copper(II) sulfate and zinc(II) oxide were catalytic in that they resulted in shorter half-lives than the blank reference without a catalyst candidate.

FIG. 2 also reveals that iron(II) sulfate, iron(III) sulfate, copper(II) sulfate and zinc(II) oxide all resulted in no further discoloration with respect to the blank reference without catalyst.

TABLE 6

| | | | | Init. degrad. | | | | |
|---|---|---|---|---|---|---|---|---|
| Exp. | Exp. | | pH | half-life t_{1/2} | | final | final | |
| No. | block | Catalyst | modifier | (sec) | ΔE_{ab}⁽¹⁾ | pH | viscosity | |
| 1-1 | 1 | Fe2(SO4)3 | H2SO4 | 639 | 6.57 | 3.0 | <20 | cP |
| 1-2 | 1 | none | none | 27639 | 17.58 | 4.0 | 20-200 | cP |
| 1-3 | 1 | Fe2(SO4)3 | none | 2061 | 18.36 | 3.0 | <20 | cP |
| 1-4 | 1 | NaI | H2SO4 | 22373 | 6.12 | 5.0 | 200-1000 | cP |
| 1-5 | 1 | CuSO4 | NaOH | 3948 | 10.80 | 4.0 | 20-200 | cP |
| 1-6 | 1 | NaI | NaOH | 16675 | 23.83 | 5.0 | 400-1000 | cP |
| 1-7 | 2 | TiO2 | H2SO4 | 13798 | 24.13 | 3.0 | <20 | cP |
| 1-8 | 2 | CuSO4 | NaOH | 419 | 5.99 | 3.5 | 20-200 | cP |
| 1-9 | 2 | FeSO4 | H2SO4 | 1222 | 6.38 | 2.5 | 10-40 | cP |
| 1-10 | 2 | KMnO4 | none | 8790 | 80.88 | 7.0 | 1000-4000 | cP |
| 1-11 | 2 | FeSO4 | none | 1466 | 6.49 | 2.5 | 10-40 | cP |
| 1-12 | 2 | ZnO | H2SO4 | 5368 | 7.11 | 4.0 | 20-200 | cP |
| 1-13 | 3 | none | NaOH | 1405 | 20.16 | 4.0 | 20-200 | cP |
| 1-14 | 3 | NaI | none | 4244 | 8.25 | 4.5 | 400-1000 | cP |
| 1-15 | 3 | KMnO4 | H2SO4 | 20615 | 47.53 | 5.0 | 400-1000 | cP |
| 1-16 | 3 | Fe2(SO4)3 | none | 2348 | 10.59 | 3.0 | <20 | cP |
| 1-17 | 3 | none | NaOH | 2333 | 5.00 | 3.5 | 20-200 | cP |
| 1-18 | 3 | TiO2 | NaOH | 4962 | 35.64 | 4.0 | 20-200 | cP |
| 1-19 | 4 | TiO2 | none | 16881 | 24.52 | 4.0 | 20-200 | cP |
| 1-20 | 4 | none | NaOH | 4144 | 2.38 | 4.0 | 20-200 | cP |
| 1-21 | 4 | ZnO | none | 5844 | 9.04 | 4.0 | 20-200 | cP |
| 1-22 | 4 | NaI | NaOH | 9639 | 12.34 | 4.5 | 200-1000 | cP |
| 1-23 | 4 | FeSO4 | NaOH | 2553 | 15.14 | 3.0 | 10-40 | cP |
| 1-24 | 4 | none | H2SO4 | 44714 | 13.48 | 4.0 | 20-200 | cP |
| 1-25 | 5 | Fe2(SO4)3 | H2SO4 | 765 | 4.86 | 2.5 | 10-40 | cP |
| 1-26 | 5 | CuSO4 | H2SO4 | 10268 | 14.96 | 3.5 | 20-200 | cP |
| 1-27 | 5 | KMnO4 | none | 14905 | 66.56 | 6.0 | 1000-4000 | cP |
| 1-28 | 5 | ZnO | NaOH | 576 | 16.01 | 4.5 | 100-200 | cP |
| 1-29 | 5 | TiO2 | NaOH | 4335 | 20.64 | 3.0 | 10-40 | cP |
| 1-30 | 5 | ZnO | none | 3584 | 5.98 | 3.5 | 100-200 | cP |
| 1-31 | 6 | KMnO4 | NaOH | 10182 | 53.46 | 5.5 | 1000-4000 | cP |
| 1-32 | 6 | NaI | none | 9993 | 5.00 | 4.5 | 400-1000 | cP |
| 1-33 | 6 | Fe2(SO4)3 | NaOH | 7471 | 9.23 | 3.0 | 20-200 | cP |
| 1-34 | 6 | CuSO4 | H2SO4 | 4144 | 3.78 | 3.5 | 20-200 | cP |
| 1-35 | 6 | none | none | 37280 | 25.92 | 4.5 | 100-200 | cP |
| 1-36 | 6 | ZnO | H2SO4 | 4358 | 3.14 | 4.5 | 100-200 | cP |
| 1-37 | 7 | KMnO4 | NaOH | 26289 | 30.76 | 5.0 | 1000-4000 | cP |
| 1-38 | 7 | ZnO | NaOH | 1580 | 2.04 | 4.5 | 100-200 | cP |
| 1-39 | 7 | CuSO4 | none | 4486 | 4.11 | 4.0 | 20-200 | cP |
| 1-40 | 7 | KMnO4 | H2SO4 | 19630 | 80.84 | 5.0 | 1000-4000 | cP |
| 1-41 | 7 | FeSO4 | H2SO4 | 729 | 6.01 | 2.5 | <20 | cP |
| 1-42 | 7 | TiO2 | none | 20804 | 21.11 | 4.5 | 100-200 | cP |
| 1-43 | 8 | TiO2 | H2SO4 | 31582 | 15.27 | 2.5 | 20-200 | cP |
| 1-44 | 8 | Fe2(SO4)3 | NaOH | 2191 | 2.56 | 2.5 | <20 | cP |
| 1-45 | 8 | CuSO4 | none | 6017 | 2.45 | 2.5 | <20 | cP |
| 1-46 | 8 | NaI | H2SO4 | 94907 | 6.16 | 5.0 | 400-1000 | cP |
| 1-47 | 8 | FeSO4 | NaOH | 2785 | 8.03 | 2.5 | <20 | cP |
| 1-48 | 8 | FeSO4 | none | 1852 | 3.20 | 2.5 | <20 | cP |

Enhancer Screening

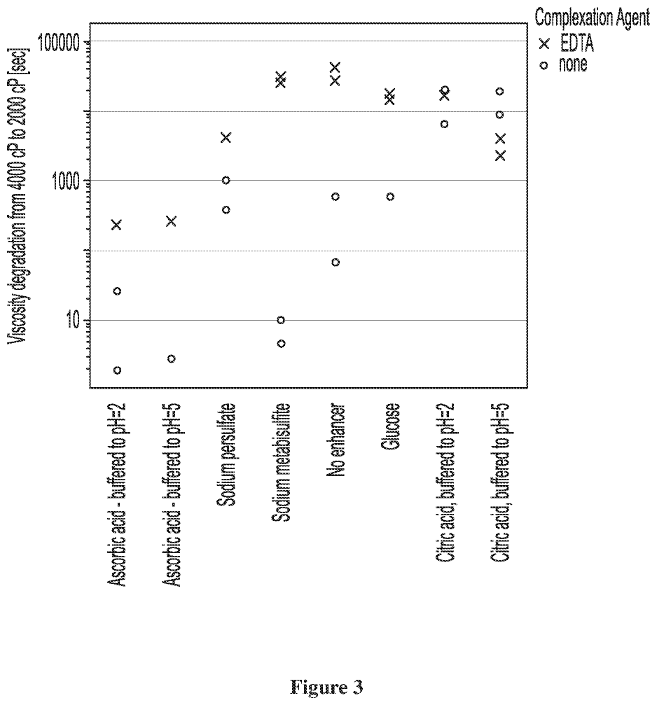

Conduct 56 experiments as listed in Table 7 using the following procedure for each experiment. Add 20 gram (g) aliquots of 2 wt % solution of METHOCEL™ E4M to a glass vial and then add where applicable catalyst stock solution (100 microliters, corresponding to 5 micromoles active catalyst) followed by sodium hydroxide (0.1N) or sulfuric acid (0.1N) solution as “pH modifier” (50 microliters corresponding to 5 micromoles protons or hydroxyl anions) where indicated. Where indicated, add EDTA (50 millimolar stock solution; 100 microliters, corresponding to 5 micromoles EDTA-Na2) followed by Fenton Enhancer (one Molar stock solution; 200 microliters diluted to one milliliter with distilled water, approximately 3.92 millimoles). Stir for 5 minutes at 300 rpm and then add H₂O₂ 30% (400 microliters, diluted to one milliliter with distilled water, approximately 3.92 millimole) by syringe. Blank reactions were run without catalyst and deionized water was added instead of hydrogen peroxide solution. Reactions are run for 3 hours at 300 rpm and 25° C. Results are in Table 7 and FIGS. 3-6.

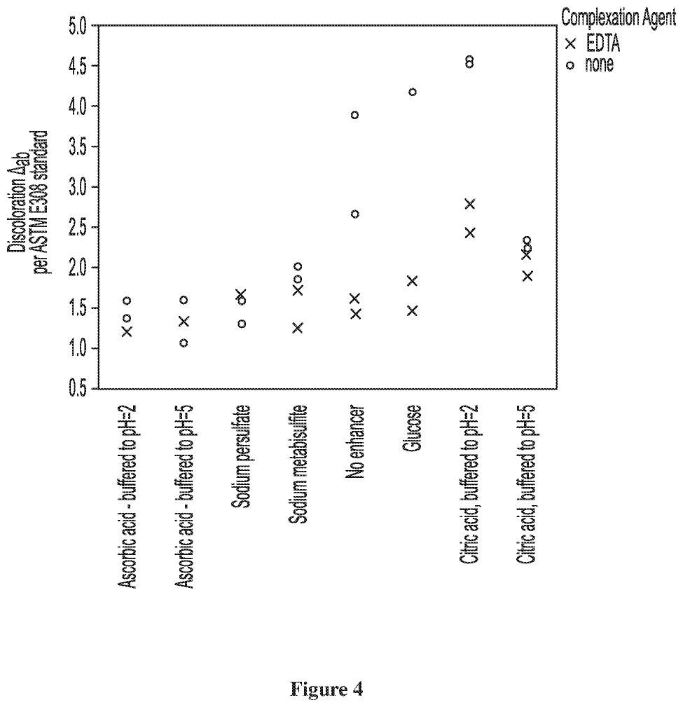

FIGS. 3 and 4 show results using iron(III) sulfate catalyst. FIG. 3 shows that ascorbic acid and sodium metabisulfite improves the reaction rate. It also reveals that inclusion of EDTA slows the reaction rate. FIG. 4 also shows that ascorbic acid, sodium persulfate and metabisulfite improve color for samples with and without EDTA.

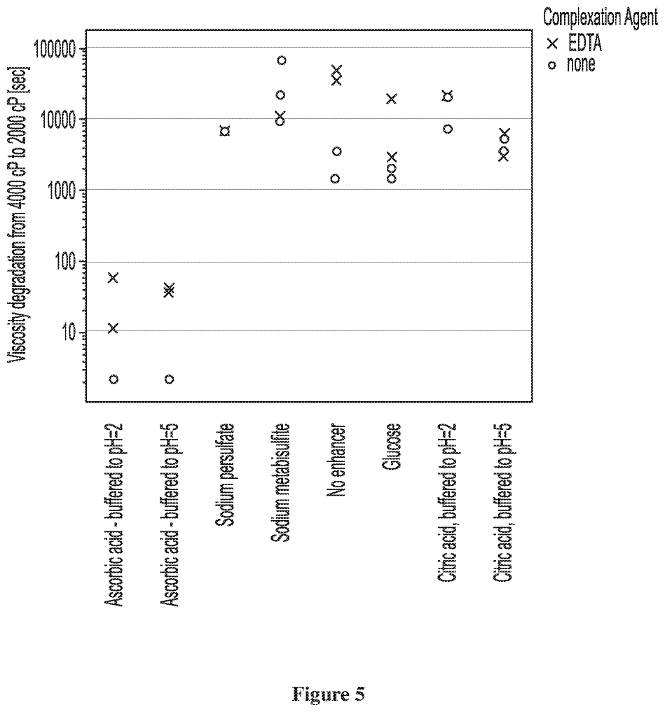

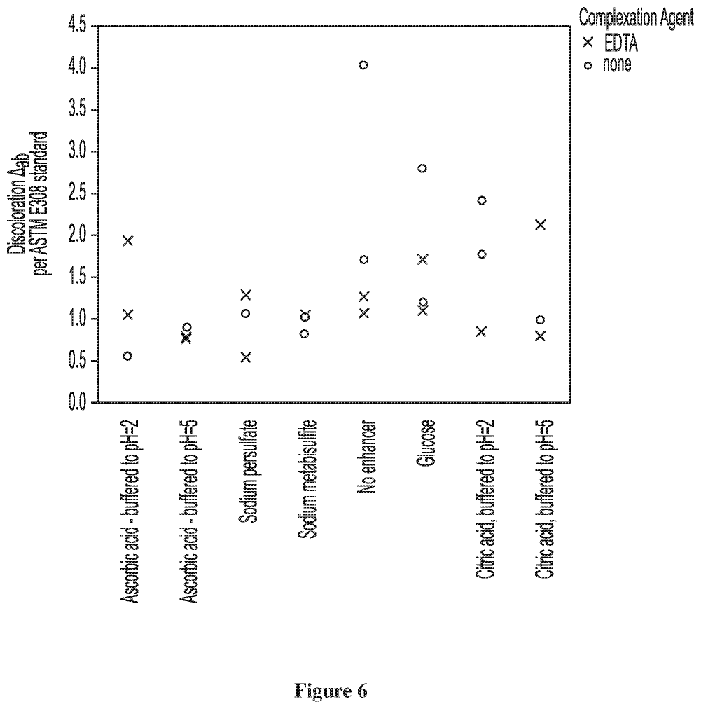

FIGS. 5 and 6 show results using copper(III) sulfate catalyst. FIG. 5 shows ascorbic acid improves reaction rate by more than two orders of magnitude. FIG. 6 also shows that ascorbic acid, sodium persulfate and metabisulfite improve color, particularly for sample without EDTA.

TABLE 7

| | | | | | Init. degrad. | | | |
|---|---|---|---|---|---|---|---|---|
| Exp. | Exp. | Catalyst and | Complexation | Fenton | half-life t_{1/2} | | final | |
| No. | block | pH modifier | agent | enhancer | (sec) | ΔE_{ab} | viscosity | |
| 2-1 | 1 | CuSO4/NaOH | none | Cit-pH 5 | n.d. | 0.97 | 10-40 | cP |
| 2-2 | 1 | CuSO4/NaOH | EDTA | Asc-pH 5 | 36 | 0.77 | 20-200 | cP |
| 2-3 | 1 | CuSO4/NaOH | EDTA | Glucose | 2817 | 1.70 | 1000-4000 | cP |
| 2-4 | 1 | Fe2(SO4)3/H2SO4 | EDTA | Cit-pH 5 | n.d. | 2.17 | 10-40 | cP |
| 2-5 | 1 | Fe2(SO4)3/H2SO4 | none | Glucose | 591 | 4.17 | <20 | cP |
| 2-6 | 1 | CuSO4/NaOH | none | none | 1391 | 1.70 | 200-1000 | cP |
| 2-7 | 1 | Fe2(SO4)3/H2SO4 | none | Asc-pH 5 | 3 | 1.59 | 20-200 | cP |
| 2-8 | 2 | CuSO4/NaOH | none | Glucose | 1971 | 1.20 | <20 | cP |
| 2-9 | 2 | Fe2(SO4)3/H2SO4 | none | bisulfite | 5 | 2.00 | <20 | cP |
| 2-10 | 2 | Fe2(SO4)3/H2SO4 | EDTA | persulfate | 4062 | 1.66 | <20 | cP |
| 2-11 | 2 | CuSO4/NaOH | none | persulfate | n.d. | 1.05 | 20-200 | cP |
| 2-12 | 2 | Fe2(SO4)3/H2SO4 | none | none | 596 | 2.67 | <20 | cP |
| 2-13 | 2 | CuSO4/NaOH | EDTA | none | 34247 | 1.06 | 20-200 | cP |
| 2-14 | 2 | CuSO4/NaOH | EDTA | bisulfite | 10955 | 1.04 | 1000-4000 | cP |
| 2-15 | 3 | Fe2(SO4)3/H2SO4 | EDTA | Cit-pH 2 | 16275 | 2.79 | 200-1000 | cP |
| 2-16 | 3 | CuSO4/NaOH | none | Cit-pH 2 | 7139 | 2.41 | 400-1000 | cP |
| 2-17 | 3 | Fe2(SO4)3/H2SO4 | EDTA | Cit-pH 5 | 2287 | 1.89 | <20 | cP |
| 2-18 | 3 | CuSO4/NaOH | EDTA | none | n.d. | 1.26 | 1000-4000 | cP |
| 2-19 | 3 | CuSO4/NaOH | none | Cit-pH 5 | 5113 | 0.99 | 20-200 | cP |
| 2-20 | 3 | Fe2(SO4)3/H2SO4 | none | none | 68 | 3.88 | <20 | cP |
| 2-21 | 3 | Fe2(SO4)3/H2SO4 | EDTA | bisulfite | 25281 | 1.71 | 1000-4000 | cP |
| 2-22 | 4 | CuSO4/NaOH | none | Cit-pH 2 | n.d. | 1.77 | 20-200 | cP |
| 2-23 | 4 | Fe2(SO4)3/H2SO4 | EDTA | Cit-pH 2 | 557035 | 2.43 | 200-1000 | cP |
| 2-24 | 4 | Fe2(SO4)3/H2SO4 | EDTA | Glucose | 14366 | 1.82 | 20-200 | cP |
| 2-25 | 4 | Fe2(SO4)3/H2SO4 | none | Asc-pH 2 | 26 | 1.58 | <20 | cP |
| 2-26 | 4 | CuSO4/NaOH | EDTA | Asc-pH 2 | 11 | 1.04 | <20 | cP |
| 2-27 | 4 | CuSO4/NaOH | EDTA | persulfate | 6699 | 1.28 | 20-200 | cP |
| 2-28 | 4 | CuSO4/NaOH | none | Glucose | 1436 | 2.79 | <20 | cP |
| 2-29 | 5 | Fe2(SO4)3/H2SO4 | none | persulfate | 1001 | 1.30 | 10-40 | cP |
| 2-30 | 5 | Fe2(SO4)3/H2SO4 | EDTA | Glucose | 17694 | 1.46 | 1000-4000 | cP |
| 2-31 | 5 | Fe2(SO4)3/H2SO4 | none | Cit-pH 5 | 8800 | 2.22 | 400-1000 | cP |
| 2-32 | 5 | CuSO4/NaOH | none | bisulfite | n.d. | 1.02 | 200-1000 | cP |
| 2-33 | 5 | Fe2(SO4)3/H2SO4 | EDTA | bisulfite | 29911 | 1.24 | 1000-4000 | cP |
| 2-34 | 5 | Fe2(SO4)3/H2SO4 | none | Cit-pH 2 | 6434 | 4.57 | 200-1000 | cP |
| 2-35 | 5 | CuSO4/NaOH | EDTA | Cit-pH 5 | 2927 | 2.11 | 100-200 | cP |
| 2-36 | 6 | CuSO4/NaOH | EDTA | bisulfite | n.d. | 1.16 | 1000-4000 | cP |
| 2-37 | 6 | Fe2(SO4)3/H2SO4 | none | bisulfite | 10 | 1.84 | <20 | cP |
| 2-38 | 6 | Fe2(SO4)3/H2SO4 | EDTA | none | 40867 | 1.60 | 20-200 | cP |
| 2-39 | 6 | Fe2(SO4)3/H2SO4 | EDTA | Asc-pH 5 | 251 | 1.33 | 10-40 | cP |
| 2-40 | 6 | Fe2(SO4)3/H2SO4 | none | Asc-pH 2 | 2 | 1.37 | 10-40 | cP |
| 2-41 | 6 | CuSO4/NaOH | none | Asc-pH 5 | 2 | 0.89 | 10-40 | cP |
| 2-42 | 6 | CuSO4/NaOH | EDTA | Glucose | 18858 | 1.10 | 10-40 | cP |
| 2-43 | 7 | CuSO4/NaOH | none | none | n.d. | 4.02 | 20-200 | cP |
| 2-44 | 7 | CuSO4/NaOH | EDTA | Asc-pH 2 | 56 | 1.93 | <20 | cP |
| 2-45 | 7 | CuSO4/NaOH | EDTA | Cit-pH 2 | n.d. | 0.84 | 1000-4000 | cP |
| 2-46 | 7 | Fe2(SO4)3/H2SO4 | EDTA | none | 27379 | 1.42 | 1000-4000 | cP |
| 2-47 | 7 | Fe2(SO4)3/H2SO4 | none | Cit-pH 2 | 19822 | 4.53 | 400-1000 | cP |
| 2-48 | 7 | CuSO4/NaOH | none | bisulfite | 8880 | 0.80 | 200-1000 | cP |
| 2-49 | 7 | CuSO4/NaOH | EDTA | Asc-pH 5 | 41 | 0.75 | <20 | cP |
| 2-50 | 8 | CuSO4/NaOH | EDTA | persulfate | n.d. | 0.53 | 20-200 | cP |
| 2-51 | 8 | Fe2(SO4)3/H2SO4 | none | persulfate | 376 | 1.59 | <20 | cP |
| 2-52 | 8 | CuSO4/NaOH | EDTA | Cit-pH 5 | 6293 | 0.79 | <20 | cP |
| 2-53 | 8 | Fe2(SO4)3/H2SO4 | EDTA | Asc-pH 2 | 231 | 1.20 | <20 | cP |
| 2-54 | 8 | Fe2(SO4)3/H2SO4 | none | Cit-pH 5 | 18857 | 2.33 | <20 | cP |
| 2-55 | 8 | CuSO4/NaOH | none | Asc-pH 2 | 2 | 0.54 | <20 | cP |
| 2-56 | 8 | Fe2(SO4)3/H2SO4 | none | Asc-pH 5 | 3 | 1.06 | <20 | cP |

Oxidizer Screening

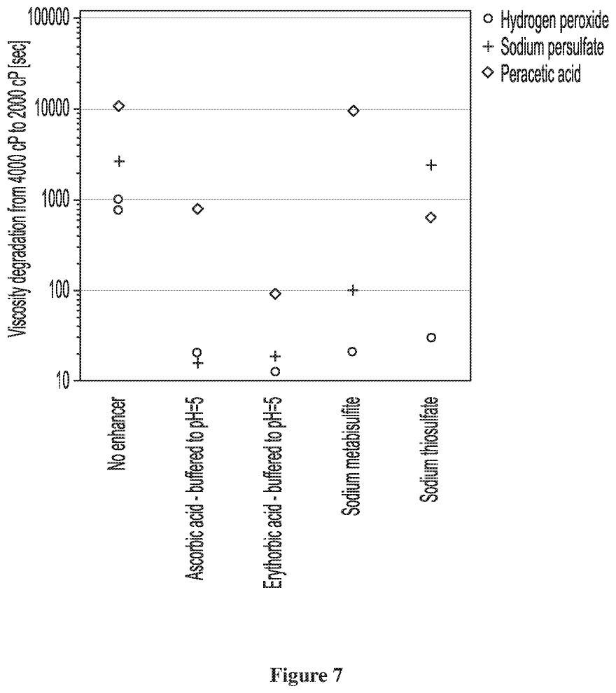

Conduct 36 experiments as listed in Table 8 using the following procedure for each experiment. Add 20 gram (g) aliquots of 2 wt % solution of METHOCEL™ E4M to a glass vial and then add where applicable catalyst stock solution (100 microliters, corresponding to 5 micromole active catalyst) followed by sodium hydroxide (0.1N) or sulfuric acid (0.1N) solution as “pH modifier” (50 microliters corresponding to 5 micromole protons or hydroxyl anions) where indicated. Where indicated, add Fenton Enhancer (one Molar stock solution; 100 microliters). Stir for 5 minutes at 300 rpm and then add stock oxidize solution as indicated in Table 8 (H₂O₂ 150 microliters; peracetic acid 310 microliters; sodium persulfate 735 microliters; all diluted to on milliliter with distilled water, approximately 1.47 millimole oxidizer) by syringe. Blank reactions were run without catalyst and deionized water was added instead of hydrogen peroxide solution. Reactions are run for 3 hours at 300 rpm and 25° C. Results are in Table 8 and FIGS. 7-10.

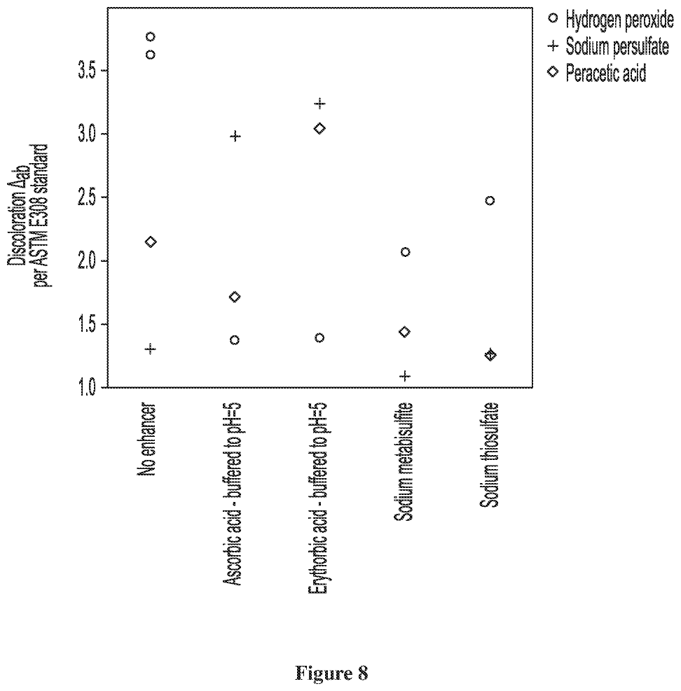

FIGS. 7 and 8 illustrate results using iron(III) sulfate catalyst. FIG. 7 illustrates ascorbic acid and erythorbic acid universally reduce degradation half-life of the reaction while sodium metabisulfite and sodium thiosulfate reduce degradation half-life for select oxidizers. FIG. 8 reveals ascorbic acid and erythorbic acid improve color only for hydrogen peroxide while sodium metabisulfite and sodium thiosulfate improve color for all oxidants.

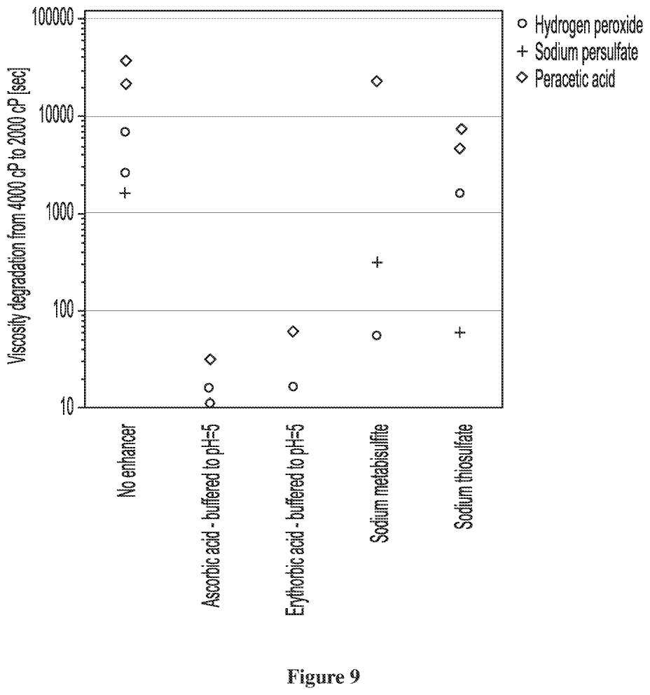

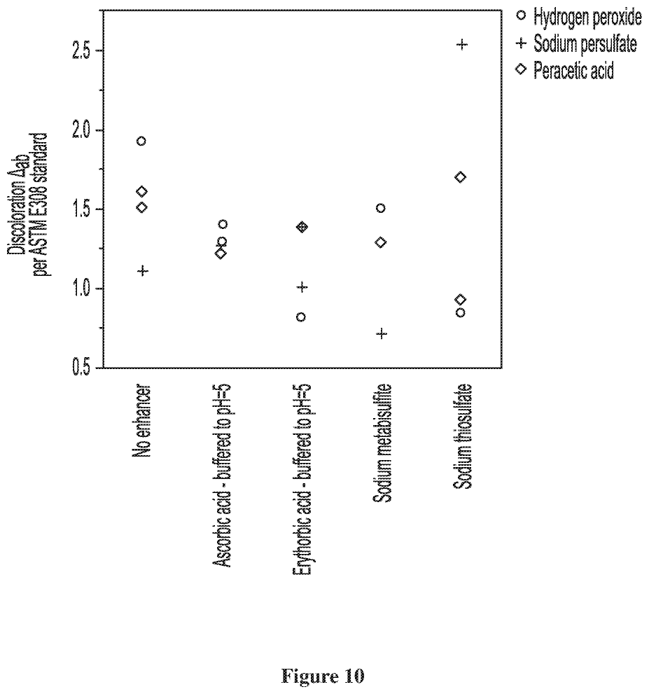

FIGS. 9 and 10 illustrate results using copper(II) sulfate catalyst. FIG. 9 reveals that ascorbic acid and erythorbic acid reduce degradation half-life for all oxidants while sodium metabisulfite and sodium thiosulfate improve degradation half-life for some oxidants.

TABLE 8

| | | | | | Init. degrad. | | final | |
|---|---|---|---|---|---|---|---|---|
| Exp. | Exp. | Catalyst and | Fenton | | half-life t_{1/2} | | viscos. | |
| No. | block | pH modifier | activator | Oxidizer | (sec) | ΔE_{ab} | (visual) | |
| 3-1 | 1 | CuSO4/NaOH | Ery-pH 5 | perac. acid | 61 | 1.38 | 200-1000 | cP |
| 3-2 | 1 | Fe2(SO4)3/H2SO4 | Asc-pH 5 | persulf. | 16 | 2.98 | <20 | cP |
| 3-3 | 1 | CuSO4/NaOH | thiosulfate | H2O2 | 1581 | 0.85 | 20-200 | cP |
| 3-4 | 1 | Fe2(SO4)3/H2SO4 | thiosulfate | perac. acid | 631 | 1.25 | 200-1000 | cP |
| 3-5 | 1 | Fe2(SO4)3/H2SO4 | Ery-pH 5 | H2O2 | 13 | 1.39 | 20-200 | cP |
| 3-6 | 1 | Fe2(SO4)3/H2SO4 | none | H2O2 | 751 | 3.62 | <20 | cP |
| 3-7 | 2 | CuSO4/NaOH | Asc-pH 5 | perac. acid | 31 | 1.22 | 200-1000 | cP |
| 3-8 | 2 | Fe2(SO4)3/H2SO4 | none | persulf. | 2662 | 1.30 | <20 | cP |
| 3-9 | 2 | CuSO4/NaOH | metabisulf. | persulf. | 311 | 0.72 | <20 | cP |
| 3-10 | 2 | Fe2(SO4)3/H2SO4 | metabisulf. | perac. acid | 9510 | 1.43 | 200-1000 | cP |
| 3-11 | 2 | CuSO4/NaOH | none | H2O2 | 2642 | 1.93 | 20-200 | cP |
| 3-12 | 2 | Fe2(SO4)3/H2SO4 | Asc-pH 5 | H2O2 | 21 | 1.37 | 20-200 | cP |
| 3-13 | 3 | CuSO4/NaOH | Asc-pH 5 | H2O2 | 11 | 1.29 | 20-200 | cP |
| 3-14 | 3 | CuSO4/NaOH | metabisulf. | H2O2 | 56 | 1.51 | 20-200 | cP |
| 3-15 | 3 | Fe2(SO4)3/H2SO4 | metabisulf. | persulf. | 101 | 1.08 | 20-200 | cP |
| 3-16 | 3 | Fe2(SO4)3/H2SO4 | thiosulfate | H2O2 | 31 | 2.47 | 10-40 | cP |
| 3-17 | 3 | CuSO4/NaOH | thiosulfate | perac. acid | 4588 | 1.70 | 200-1000 | cP |
| 3-18 | 3 | CuSO4/NaOH | thiosulfate | persulf. | 61 | 2.54 | 100-200 | cP |
| 3-19 | 4 | CuSO4/NaOH | none | perac. acid | 21297 | 1.61 | 1000-4000 | cP |
| 3-20 | 4 | CuSO4/NaOH | Asc-pH 5 | persulf. | 11 | 1.27 | <20 | cP |
| 3-21 | 4 | CuSO4/NaOH | Ery-pH 5 | persulf. | 3 | 1.01 | <20 | cP |
| 3-22 | 4 | CuSO4/NaOH | thiosulfate | perac. acid | 7279 | 0.92 | 200-1000 | cP |
| 3-23 | 4 | Fe2(SO4)3/H2SO4 | thiosulfate | persulf. | 2422 | 1.27 | 1000-4000 | cP |
| 3-24 | 4 | Fe2(SO4)3/H2SO4 | Asc-pH 5 | perac. acid | 781 | 1.71 | 200-1000 | cP |
| 3-25 | 5 | CuSO4/NaOH | Asc-pH 5 | H2O2 | 16 | 1.40 | <20 | cP |
| 3-26 | 5 | CuSO4/NaOH | none | persulf. | 1611 | 1.12 | 20-200 | cP |
| 3-27 | 5 | Fe2(SO4)3/H2SO4 | none | H2O2 | 1016 | 3.77 | 20-200 | cP |
| 3-28 | 5 | CuSO4/NaOH | Ery-pH 5 | H2O2 | 16 | 0.82 | <20 | cP |
| 3-29 | 5 | Fe2(SO4)3/H2SO4 | Ery-pH 5 | persulf. | 19 | 3.24 | <20 | cP |
| 3-30 | 5 | CuSO4/NaOH | none | perac. acid | 36477 | 1.51 | 1000-4000 | cP |
| 3-31 | 6 | Fe2(SO4)3/H2SO4 | Ery-pH 5 | perac. acid | 91 | 3.04 | 100-200 | cP |
| 3-32 | 6 | CuSO4/NaOH | Ery-pH 5 | persulf. | 5 | 1.39 | <20 | cP |
| 3-33 | 6 | Fe2(SO4)3/H2SO4 | metabisulf. | H2O2 | 21 | 2.07 | <20 | cP |
| 3-34 | 6 | Fe2(SO4)3/H2SO4 | none | perac. acid | 10736 | 2.14 | <20 | cP |
| 3-35 | 6 | CuSO4/NaOH | none | H2O2 | 6759 | 1.93 | <20 | cP |
| 3-36 | 6 | CuSO4/NaOH | metabisulf. | perac. acid | 22344 | 1.29 | 1000-4000 | cP |

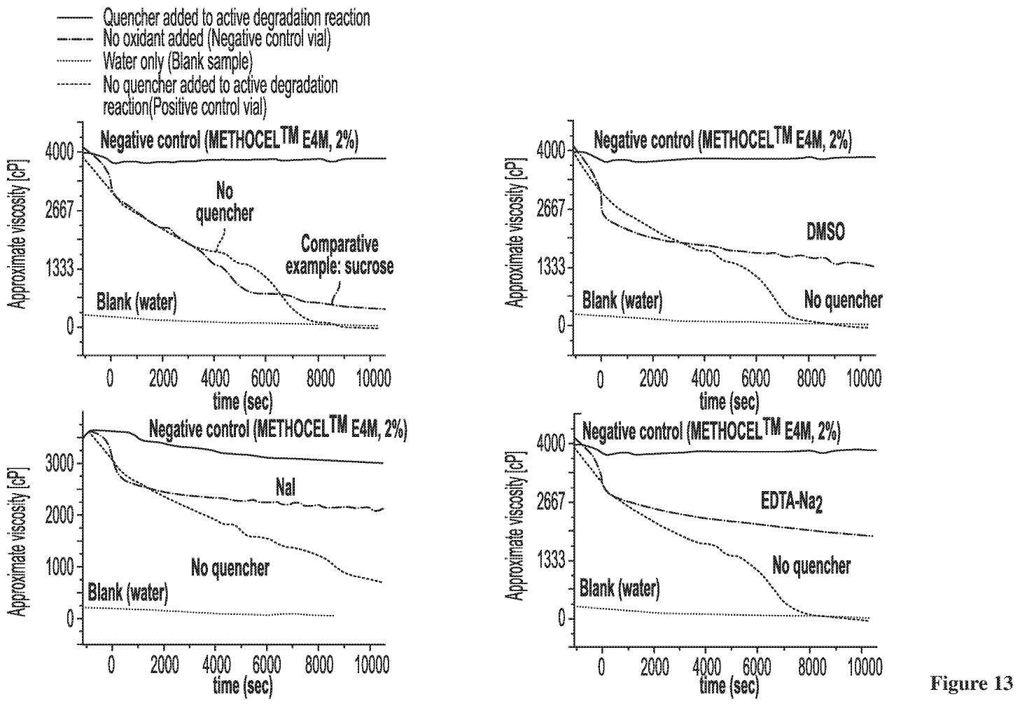

Quencher Screening
(a) Quencher Screen I. Add 20 g aliquots of 2 wt % METHOCEL E4M cellulose ether solution to seven separate glass vials. Into an eighth glass vial add water as a blank sample. Add iron(III) sulfate stock solution (100 microliters, corresponding to 5 micromoles active catalyst) followed by sulfuric acid solution (0.1N)(50 microliters, corresponding to 5 micromol protons). No catalyst is added to the negative control vial and the blank sample. Stir the reactions for 5 minutes at 300 rpm and then add 30% H2O2 (400 microliters, diluted to one milliliter with distilled water, approximately 3.92 millimole) by syringe except for the negative control vial and blank sample. After 20 minutes, quenching test solution (1.5 milliliters of one of the following: aqueous urea 1M; tannic acid 0.2M, cysteine 1M, potassium metabisulfite 0.5 M, sodium iodide 0.01 M, sodium thiosulfate 1M) was added to separate vials except to the negative and positive control vials and the blank sample. Record viscosity degradation for three hours. The degradation curve for the sodium iodide sample in comparison to the blank, negative and positive control samples is shown in FIG. 13. Measure H202 content by dip testing with Baker hydrogen peroxide TestStrips. Peroxide test trips were negative (indicating successful quenching) for metabisulfite, thiosulfate, cysteine and the negative control vial, while they were positive for the other samples.
(b) Quencher Screen II. Add 20 g aliquots of 2 wt % METHOCEL E4M cellulose ether solution to seven separate glass vials. Into an eight vial water is added as a blank sample. Then add iron(III) sulfate stock solution (10 microliter ,corresponding to 5 micromoles active catalyst), followed by sulfuric acid solution (0.1 N)(50 microliters, corresponding to 5 micromoles protons). No catalyst is added to the negative control vial and the blank sample. Stir reactions for 5 minutes at 300 rpm and then add 30% H₂O₂ (400 microliters, diluted to one milliliter with distilled water, approximately 3.92 millimole) via syringe except for the negative control vial and the blank sample. After 20 minutes, add to each vial a quenching test solution (1.5 mL of: (a) sucrose 1 M; (b) sodium hypophosphite 1M; (c) dimethyl sulfoxide in water 1 M; (d) EDTA-Na2 50 mM; or (e) 2.0 mL of sodium hypochlorite solution approximately 0.63 M NaOCl) to separate vials except to the negative and positive controls and the blank sample. Record viscosity degradation for three hours. Degradation curves for the sucrose, dimethyl sulfoxide, EDTA-Na₂ and DMSO, in comparison to the blank sample, negative and positive control samples are shown in FIG. 13. Measure H2O2 content with Baker hydrogen peroxide Test Strips. Peroxide test strips were negative for hypochlorite, diminished for hypophosphite and significantly diminished for DMSO and >100 mg/L for sucrose and EDTA-Na.
(c) Quencer Screen III. Run the screen similar to the previous screens using as quenching test solutions (a) 1.5 mL of ascorbic acid (1 M, buffered at pH 2 with NaOH); (b) 1.5 mL of ascorbic acid (1 M, buffered at pH 5 with NaOH); (c) 1.5 mL of erythorbic acid (1 M, buffered at pH 5 with NaOH), (d) sodium hypophosphite (1 M) and (e) citric acid (1 M, buffered at pH 5 with NaOH). Peroxy test strips were negative for ascorbic acid at pH 2 and 5 and for erythorbic acid. The test strip was as >100 mg/L for hypophosphite and citric acid.
(d) Catalase Quencher: Series I. Prepare fresh catalase stock solution by dissolving 10 milligrams of bovine catalase (Aldrich) in 5 milliliters cool, microfiltered sodium phosphate buffer (50 mM, pH 7) resulting in a solution with the activity of 4,000-10,000 U/mL (per specifications provided from the manufacturer). Dilute a 1.5 mL aliquot of this solution with additional phosphate buffer to a total volume of 6 mL, resulting in a 1,000-2,500 U/mL catalase stock solution. From the second stock solution, dilute a 1.5 mL aliquot further with phosphate buffer to total volume of 6 mL, resulting in a 250-625 U/mL solution. Store the solutions in a refrigerator until used. Into glass vials with 20 g aliquots of 2 wt % METHOCEL E4M solution add iron(III) sulfate stock solution (100 microliters, corresponding to 5 micromoles active catalyst) followed by sulfuric acid solution (0.1 N) (50 microliter, corresponding to 5 micromoles protons). No catalyst was added to the negative control vial. Stir the reactions for 5 minutes at 300 rpm and then add 30% H₂O₂ (400 microliter, diluted to 1 mL with distilled water, approximately 3.92 mmol) via syringe except for the negative control vial. After 20 minutes, add sodium carbonate buffer (2 mL, 500 mM) to the three vials. One mL aliquots of the three bovine catalase solutions were added, one to each of the three vials without phosphate buffer and one of each to the three reaction vials with phosphate buffer. No catalase was added to the negative and positive control reactions. The viscosity degradation of all reactions was monitored for 3 hours after which H₂O₂ content was measured by dip testing with Baker hydrogen peroxide TestStrips. No catalase-containing reactions contained any remaining hydrogen peroxide.
(e) Catalase Quencher: Series II. Prepare fresh catalase stock solution by dissolving 5 mg of bovine catalase in 10 mL cool, microfiltered sodium phosphate buffer (50 mM, pH7), resulting in an activity of 1,000-2,500 U per manufacturer specifications. Keep the stock solution at 5° C. until used. Prepare test solutions in six glass vials. Into vials 1 and 2 add 20 g aliquots of 2 wt % METHOCEL E4M solution and iron(III) sulfate stock solution (100 microliters , corresponding to 5 micromole active catalyst), and sulfuric acid solution (0.1N)(50 microliters, corresponding to 5 micromoles of protons) and 1 molar aqueous erythorbic acid, buffered to pH 5 with sodium hydroxide (100 microliters). Into vials 3 and 4 add 20 g aliquots of 2 wt % METHOCEL E4M and copper(II) sulfate stock solution (100 microliters, corresponding to 5 micromole active catalyst), aqueous erythorbic acid, buffered to pH 5 with sodium hydroxide (100 microliters). Into vials 5 and 6 add 20 g aliquots of 2 wt % METHOCEL E4M and copper(II) sulfate stock solution (100 microliters, corresponding to 5 micromole active catalyst), followed by sodium hydroxide solution (0.1 N)(50 microliters, corresponding to 5 micromole hydroxyl anions). Monitor the viscosity degradation reaction for all of the vials for 3 hours after which H202 content was measured by dip testing with Baker hydrogen peroxide TestStrips. All catalase-containing reactions did not contain any remaining hydrogen peroxide.

### Side-By-Side Comparison of Cellulose Ether Degradation

To illustrate the improvement of reaction kinetics of the presently claimed invention, several oxidation methods were performed using the solution phase screening technique. For each reaction, 20 g of a 2 wt % METHOCEL E4M solution was placed into a vial and stirred for 5 minutes. Then, additives described below were added and the viscosity change of the solution over time recorded for the solution in the vial.

Blank. For the blank sample, the solution was stirred 5 minutes and then 200 microliters of water was added to solution and the solution was stirred for an additional 3 hours.

Hydrogen Peroxide Only. For a hydrogen peroxide only run, the solution was stirred 5 minutes and then 4 mmol H202 was added to the cellulose ether solution and the solution stirred for 3 hours monitoring viscosity change.

Hydrogen Peroxide/Iron sulfate. For the hydrogen peroxide/iron sulfate run, the solution was stirred 5 minutes and then 2.5 micromoles of iron(III) sulfate was added and the resulting solution stirred for 5 minutes and then 4 millimoles of H₂O₂ was added and the solution stirred for 3 hours monitoring viscosity change.

Hydrogen peroxide/iron sulfate/ascorbic acid run. For the hydrogen peroxide/iron sulfate/ascorbic acid run, the solution was stirred 5 minutes and then 2.5 micromoles of iron(III) sulfate and 200 micromoles of ascorbic acid were added to the solution and the resulting solution stirred for 5 minutes and then 4 millimoles of H202 was added and the solution stirred for 3 hours monitoring viscosity change.

Reduced Load—Hydrogen peroxide/iron sulfate/ascorbic acid run. For this run, do the same as the previous run except use 100 micromoles of ascorbic acid.

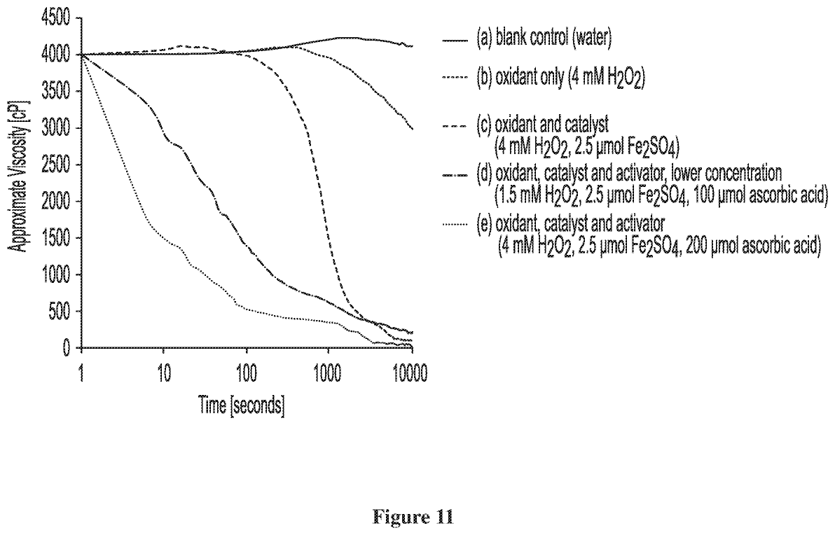

The results from these runs are plotted in FIG. 11 showing change in solution viscosity over time. The results indicate a dramatic drop in viscosity for solutions with the components of the presently claimed invention.

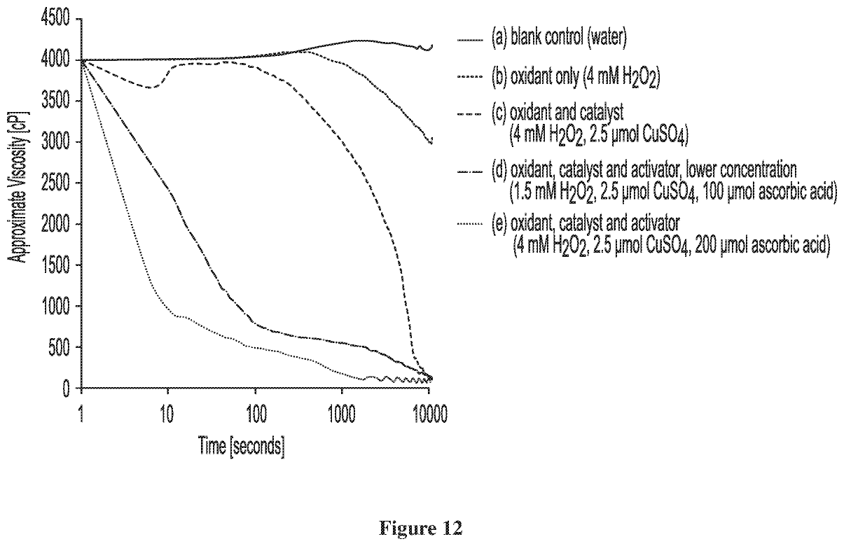

Copper(II) Sulfate Runs. The last three runs above are repeated using copper(II) sulfate instead of iron(III) sulfate. The results are plotted in FIG. 12 and show that copper(II) sulfate formulations also produce a dramatic drop in viscosity in the context of the present invention.

What is claimed is:

1. A process for preparing cellulose ether, the process comprising:
(a) alkylation and etherification of cellulose to form an initial cellulose ether;
(b) washing and filtering the initial cellulose ether to produce a washed cellulose ether;
(c) optionally, granulating the washed cellulose ether;
(d) compounding the washed cellulose ether to form a compounded cellulose ether dough;
(e) optionally, disposing the cellulose ether into a buffer tank; and
(f) drying the compounded cellulose ether dough to obtain a final cellulose ether
having a lower viscosity than the initial cellulose ether;
wherein the process is characterized by:
(i) introducing an aqueous catalyst that is a redox active transition metal based catalyst during at least one of the following steps: granulation (c), compounding (d), mixing step (e), and drying step (f); and
(ii) introducing a peroxy-containing oxidizer during at least one of the following steps: granulation (c), compounding (d), mixing step (e), and drying step (f); and
(iii) introducing an aqueous enhancer during at least one of the following steps: granulation (c), compounding (d), and mixing step (e); wherein the aqueous enhancer is selected from a group consisting of 5-substituted 3,4-dihydroxyfuranone, metabisulfite salt, sulfite salt, thiosulfate salt and sulfur dioxide; and
(iv) being free of drying and isolating cellulose ether after the alkylation in step (a) and before the drying the compounded cellulose ether to obtain the final cellulose ether in step (f).

2. The process of claim 1, wherein the catalyst is one or any combination of more than one component selected from a group consisting of iron salts, copper salts and zinc(II) oxide.

3. The process of claim 2, wherein the catalyst is one or any combination of more than one component selected from a group consisting of iron(II) sulfate, iron(III) sulfate, copper sulfate and zinc(II) oxide.

4. The process of claim 1, wherein the peroxy-containing oxidizer is one or any combination of more than one component selected from a group consisting of hydrogen peroxide, inorganic persulfate and organic persulfate.

5. The process of claim 1, wherein the amount of catalyst introduced is 0.01 to one weight-percent relative to weight of cellulose ether and the oxidizer is introduced at a concentration in a range of 1-500 times the weight of catalyst that is introduced.

6. The process of claim 1, wherein the cellulose ether is impact milled during and/or after the drying step (f).

7. The process of claim 6, wherein water is added to the cellulose ether prior to the drying step (f) so as to achieve a total water content of 45-75 weight-percent based on combined weight of water and cellulose ether.

8. The process of claim 1, wherein the aqueous enhancer is selected from a group consisting of ascorbic acid and erythorbic acid.

9. The process of claim 1, wherein the weight of the aqueous enhancer that is introduced is in a range of 0.01 to 100 times the weight of catalyst introduced.

10. The process of claim 8, wherein the process further comprises introducing a quencher after addition of catalyst, oxidizer, and enhancer at any time during or after compounding step (d); wherein the quencher is one or any combination of more than one component selected from a group consisting of EC1.11.1 class peroxidases, metabisulfite salt, sulfite salt, thiosulfate salt, sulfur dioxide, citric acid, iodide salt, manganese oxides and dioxides and salts thereof, chelants, ascorbic acid and erythorbic acid.
